(19) United States
(12) Patent Application Publication
(10) Pub. No.: US 2026/0280660 A1
(43) Pub. Date: Sep. 17, 2026

(54) CODEBOOK DESIGN FOR NEAR-FIELD COMMUNICATION

(71) Applicant: MEDIATEK INC., Hsinchu City (TW)

(72) Inventor: Lung-Sheng TSAI, Hsinchu City (TW)

(73) Assignee: MEDIATEK INC., Hsinchu City (TW)

(21) Appl. No.: 19/472,859

(22) PCT Filed: Nov. 8, 2024
(86) PCT No.: PCT/CN2024/130696

§ 371 Date: Oct. 6, 2025

Related U.S. Application Data
(60) Provisional application No. 63/597,351, filed on Nov. 9, 2023.

(51) Int. Cl. H04B 7/06; H04B 5/43

(52) U.S. Cl. CPC H04B 7/0639; H04B 5/43; H04B 7/0626

(57) ABSTRACT

In an aspect of the disclosure, a method, a computer-readable medium, and an apparatus are provided. The apparatus may be a UE. The UE reports, to a base station, a parameter set associated with a codebook determined based on a quadratic model. The parameter set is used for determining, based on the codebook, phase adjustments for signals to be transmitted by the base station. The UE receives, from the base station, the signals transmitted in accordance with the parameter set.

### CROSS-REFERENCE TO RELATED APPLICATION(S)

This application claims the benefits of U.S. Provisional Application Ser. No. 63/597,351, entitled “Codebook design for near-field communication” and filed on Nov. 9, 2023, which is expressly incorporated by reference herein in its entirety.

### FIELD

The present disclosure relates generally to wireless communications, and more particularly, to techniques of codebook design for near-field communication systems that incorporate quadratic phase compensation to model phase variations across antenna arrays.

### BACKGROUND

The statements in this section merely provide background information related to the present disclosure and may not constitute prior art.

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be a UE. The UE reports, to a base station, a parameter set associated with a codebook determined based on a quadratic model. The parameter set is used for determining, based on the codebook, phase adjustments for signals to be transmitted by the base station. The UE receives, from the base station, the signals transmitted in accordance with the parameter set.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network.

FIG. 2 is a diagram illustrating a base station in communication with a UE in an access network.

FIG. 3 illustrates an example logical architecture of a distributed access network.

FIG. 4 illustrates an example physical architecture of a distributed access network.

FIG. 5 is a diagram showing an example of a DL-centric slot.

FIG. 6 is a diagram showing an example of an UL-centric slot.

FIG. 7 is a diagram illustrating a simplified spatial arrangement of an antenna array and a UE.

FIG. 8 is a diagram illustrating path length differences between a RF source and various antenna elements in an antenna array within a Far Field scenario.

FIG. 9 is a diagram illustrating path length differences between a RF source and various antenna elements in an antenna array within a Near Field scenario.

FIG. 10(A) is a diagram illustrating an example curve that represents the relationship between the propagation distance from various antennas to a UE and the difference in index numbers between a reference antenna and an additional antenna.

FIG. 10(B) is a diagram illustrating another example curve that represents the relationship between the propagation distance from various antennas to a UE and the difference in index numbers between a reference antenna and an additional antenna.

FIG. 11(A) is a diagram illustrating an example basis defined in a NR codebook.

FIG. 11(B) is a table illustrating a codebook for 1-layer CSI reporting.

FIG. 12 illustrates a flow chart of a process for near-field communication based on a codebook.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunications systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example aspects, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

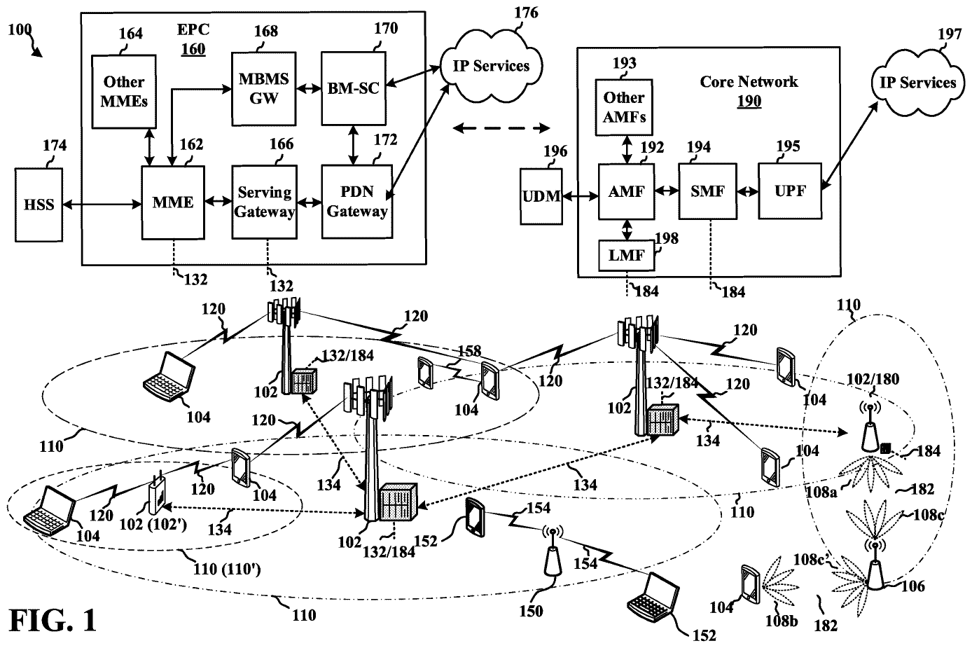

FIG. 1 is a diagram illustrating an example of a wireless communications system and an access network 100. The wireless communications system (also referred to as a wireless wide area network (WWAN)) includes base stations 102, UEs 104, an Evolved Packet Core (EPC) 160, and another core network 190 (e.g., a 5G Core (5GC)). The base stations 102 may include macrocells (high power cellular base station) and/or small cells (low power cellular base station). The macrocells include base stations. The small cells include femtocells, picocells, and microcells.

The base stations 102 configured for 4G LTE (collectively referred to as Evolved Universal Mobile Telecommunications System (UMTS) Terrestrial Radio Access Network (E-UTRAN)) may interface with the EPC 160 through backhaul links 132 (e.g., SI interface). The base stations 102 configured for 5G NR (collectively referred to as Next Generation RAN (NG-RAN)) may interface with core network 190 through backhaul links 184. In addition to other functions, the base stations 102 may perform one or more of the following functions: transfer of user data, radio channel ciphering and deciphering, integrity protection, header compression, mobility control functions (e.g., handover, dual connectivity), inter cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160 or core network 190) with each other over backhaul links 134 (e.g., X2 interface). The backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to 7 MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, FlashLinQ, WiMedia, Bluetooth, ZigBee, Wi-Fi based on the IEEE 802.11 standard, LTE, or NR.

The wireless communications system may further include a Wi-Fi access point (AP) 150 in communication with Wi-Fi stations (STAs) 152 via communication links 154 in a 5 GHz unlicensed frequency spectrum. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same 5 GHz unlicensed frequency spectrum as used by the Wi-Fi AP 150. The small cell 102′, employing NR in an unlicensed frequency spectrum, may boost coverage to and/or increase capacity of the access network.

A base station 102, whether a small cell 102′ or a large cell (e.g., macro base station), may include an eNB, gNodeB (gNB), or another type of base station. Some base stations, such as gNB 180 may operate in a traditional sub 6 GHz spectrum, in millimeter wave (mmW) frequencies, and/or near mmW frequencies in communication with the UE 104. When the gNB 180 operates in mmW or near mmW frequencies, the gNB 180 may be referred to as an mmW base station. Extremely high frequency (EHF) is part of the RF in the electromagnetic spectrum. EHF has a range of 30 GHz to 300 GHz and a wavelength between 1 millimeter and 10 millimeters. Radio waves in the band may be referred to as a millimeter wave. Near mmW may extend down to a frequency of 3 GHz with a wavelength of 100 millimeters. The super high frequency (SHF) band extends between 3 GHz and 30 GHz, also referred to as centimeter wave. Communications using the mmW/near mmW radio frequency band (e.g., 3 GHz-300 GHz) has extremely high path loss and a short range. The mmW base station 180 may utilize beamforming 182 with the UE 104 to compensate for the extremely high path loss and short range.

The base station 180 may transmit a beamformed signal to the UE 104 in one or more transmit directions 108a. The UE 104 may receive the beamformed signal from the base station 180 in one or more receive directions 108b. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include a Access and Mobility Management Function (AMF) 192, other AMFs 193, a location management function (LMF) 198, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the SMF 194 provides QoS flow and session management. All user Internet protocol (IP) packets are transferred through the UPF 195. The UPF 195 provides UE IP address allocation as well as other functions. The UPF 195 is connected to the IP Services 197. The IP Services 197 may include the Internet, an intranet, an IP Multimedia Subsystem (IMS), a PS Streaming Service, and/or other IP services.

The base station may also be referred to as a gNB, Node B, evolved Node B (eNB), an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

Although the present disclosure may reference 5G New Radio (NR), the present disclosure may be applicable to other similar areas, such as LTE, LTE-Advanced (LTE-A), Code Division Multiple Access (CDMA), Global System for Mobile communications (GSM), or other wireless/radio access technologies.

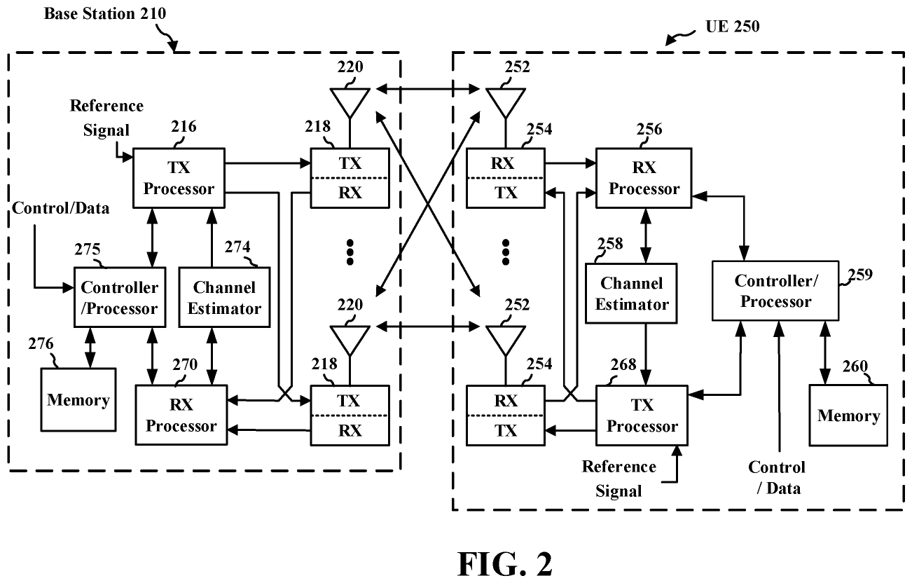

FIG. 2 is a block diagram of a base station 210 in communication with a UE 250 in an access network. In the DL, IP packets from the EPC 160 may be provided to a controller/processor 275. The controller/processor 275 implements layer 3 and layer 2 functionality. Layer 3 includes a radio resource control (RRC) layer, and layer 2 includes a packet data convergence protocol (PDCP) layer, a radio link control (RLC) layer, and a medium access control (MAC) layer. The controller/processor 275 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 216 and the receive (RX) processor 270 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 216 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 274 may be used to determine the coding and modulation scheme, as well as for spatial processing. The channel estimate may be derived from a reference signal and/or channel condition feedback transmitted by the UE 250. Each spatial stream may then be provided to a different antenna 220 via a separate transmitter 218TX. Each transmitter 218TX may modulate an RF carrier with a respective spatial stream for transmission.

At the UE 250, each receiver 254RX receives a signal through its respective antenna 252. Each receiver 254RX recovers information modulated onto an RF carrier and provides the information to the receive (RX) processor 256. The TX processor 268 and the RX processor 256 implement layer 1 functionality associated with various signal processing functions. The RX processor 256 may perform spatial processing on the information to recover any spatial streams destined for the UE 250. If multiple spatial streams are destined for the UE 250, they may be combined by the RX processor 256 into a single OFDM symbol stream. The RX processor 256 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 210. These soft decisions may be based on channel estimates computed by the channel estimator 258. The soft decisions are then decoded and deinterleaved to recover the data and control signals that were originally transmitted by the base station 210 on the physical channel. The data and control signals are then provided to the controller/processor 259, which implements layer 3 and layer 2 functionality.

The controller/processor 259 can be associated with a memory 260 that stores program codes and data. The memory 260 may be referred to as a computer-readable medium. In the UL, the controller/processor 259 provides demultiplexing between transport and logical channels, packet reassembly, deciphering, header decompression, and control signal processing to recover IP packets from the EPC 160. The controller/processor 259 is also responsible for error detection using an ACK and/or NACK protocol to support HARQ operations.

Similar to the functionality described in connection with the DL transmission by the base station 210, the controller/processor 259 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 258 from a reference signal or feedback transmitted by the base station 210 may be used by the TX processor 268 to select the appropriate coding and modulation schemes, and to facilitate spatial processing. The spatial streams generated by the TX processor 268 may be provided to different antenna 252 via separate transmitters 254TX. Each transmitter 254TX may modulate an RF carrier with a respective spatial stream for transmission. The UL transmission is processed at the base station 210 in a manner similar to that described in connection with the receiver function at the UE 250. Each receiver 218RX receives a signal through its respective antenna 220. Each receiver 218RX recovers information modulated onto an RF carrier and provides the information to a RX processor 270.

The controller/processor 275 can be associated with a memory 276 that stores program codes and data. The memory 276 may be referred to as a computer-readable medium. In the UL, the controller/processor 275 provides demultiplexing between transport and logical channels, packet reassembly, deciphering, header decompression, control signal processing to recover IP packets from the UE 250. IP packets from the controller/processor 275 may be provided to the EPC 160. The controller/processor 275 is also responsible for error detection using an ACK and/or NACK protocol to support HARQ operations.

New radio (NR) may refer to radios configured to operate according to a new air interface (e.g., other than Orthogonal Frequency Divisional Multiple Access (OFDMA)-based air interfaces) or fixed transport layer (e.g., other than Internet Protocol (IP)). NR may utilize OFDM with a cyclic prefix (CP) on the uplink and downlink and may include support for half-duplex operation using time division duplexing (TDD). NR may include Enhanced Mobile Broadband (eMBB) service targeting wide bandwidth (e.g. 80 MHz beyond), millimeter wave (mmW) targeting high carrier frequency (e.g. 60 GHz), massive MTC (mMTC) targeting non-backward compatible MTC techniques, and/or mission critical targeting ultra-reliable low latency communications (URLLC) service.

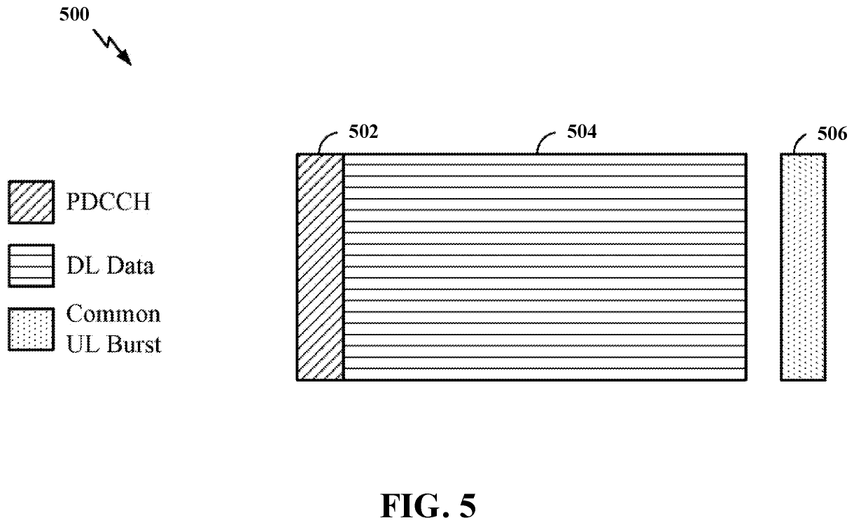

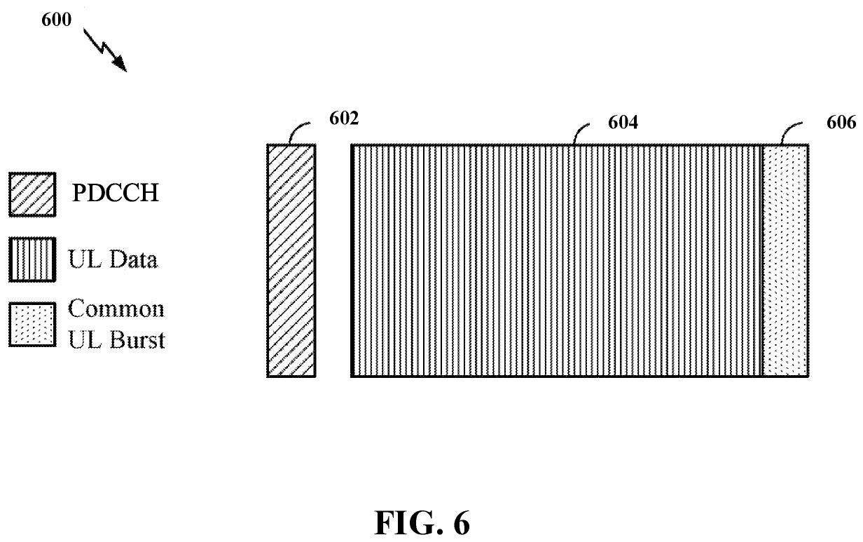

A single component carrier bandwidth of 100 MHz may be supported. In one example, NR resource blocks (RBs) may span 12 sub-carriers with a sub-carrier bandwidth of 60 kHz over a 0.25 ms duration or a bandwidth of 30 kHz over a 0.5 ms duration (similarly, 50 MHz BW for 15 kHz SCS over a 1 ms duration). Each radio frame may consist of 10 subframes (10, 20, 40 or 80 NR slots) with a length of 10 ms. Each slot may indicate a link direction (i.e., DL or UL) for data transmission and the link direction for each slot may be dynamically switched. Each slot may include DL/UL data as well as DL/UL control data. UL and DL slots for NR may be as described in more detail below with respect to FIGS. 5 and 6.

The NR RAN may include a central unit (CU) and distributed units (DUs). A NR BS (e.g., gNB, 5G Node B, Node B, transmission reception point (TRP), access point (AP)) may correspond to one or multiple BSs. NR cells can be configured as access cells (ACells) or data only cells (DCells). For example, the RAN (e.g., a central unit or distributed unit) can configure the cells. DCells may be cells used for carrier aggregation or dual connectivity and may not be used for initial access, cell selection/reselection, or handover. In some cases DCells may not transmit synchronization signals (SS) in some cases DCells may transmit SS. NR BSs may transmit downlink signals to UEs indicating the cell type. Based on the cell type indication, the UE may communicate with the NR BS. For example, the UE may determine NR BSs to consider for cell selection, access, handover, and/or measurement based on the indicated cell type.

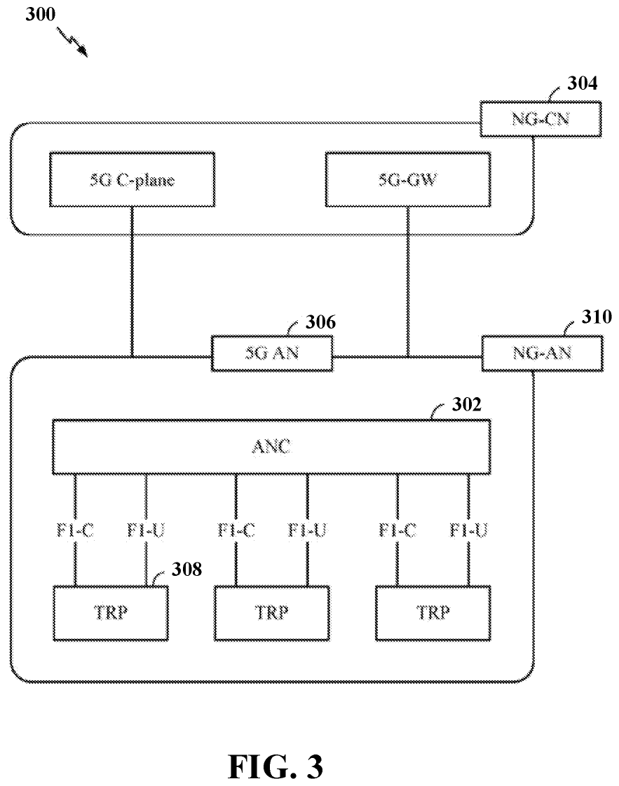

FIG. 3 illustrates an example logical architecture of a distributed RAN 300, according to aspects of the present disclosure. A 5G access node 306 may include an access node controller (ANC) 302. The ANC may be a central unit (CU) of the distributed RAN. The backhaul interface to the next generation core network (NG-CN) 304 may terminate at the ANC. The backhaul interface to neighboring next generation access nodes (NG-ANs) 310 may terminate at the ANC. The ANC may include one or more TRPs 308 (which may also be referred to as BSs, NR BSs, Node Bs, 5G NBs, APs, or some other term). As described above, a TRP may be used interchangeably with “cell.”

The TRPs 308 may be a distributed unit (DU). The TRPs may be connected to one ANC (ANC 302) or more than one ANC (not illustrated). For example, for RAN sharing, radio as a service (RaaS), and service specific ANC deployments, the TRP may be connected to more than one ANC. A TRP may include one or more antenna ports. The TRPs may be configured to individually (e.g., dynamic selection) or jointly (e.g., joint transmission) serve traffic to a UE.

The local architecture of the distributed RAN 300 may be used to illustrate fronthaul definition. The architecture may be defined that support fronthauling solutions across different deployment types. For example, the architecture may be based on transmit network capabilities (e.g., bandwidth, latency, and/or jitter). The architecture may share features and/or components with LTE. According to aspects, the next generation AN (NG-AN) 310 may support dual connectivity with NR. The NG-AN may share a common fronthaul for LTE and NR.

The architecture may enable cooperation between and among TRPs 308. For example, cooperation may be preset within a TRP and/or across TRPs via the ANC 302. According to aspects, no inter-TRP interface may be needed/present.

According to aspects, a dynamic configuration of split logical functions may be present within the architecture of the distributed RAN 300. The PDCP, RLC, MAC protocol may be adaptably placed at the ANC or TRP.

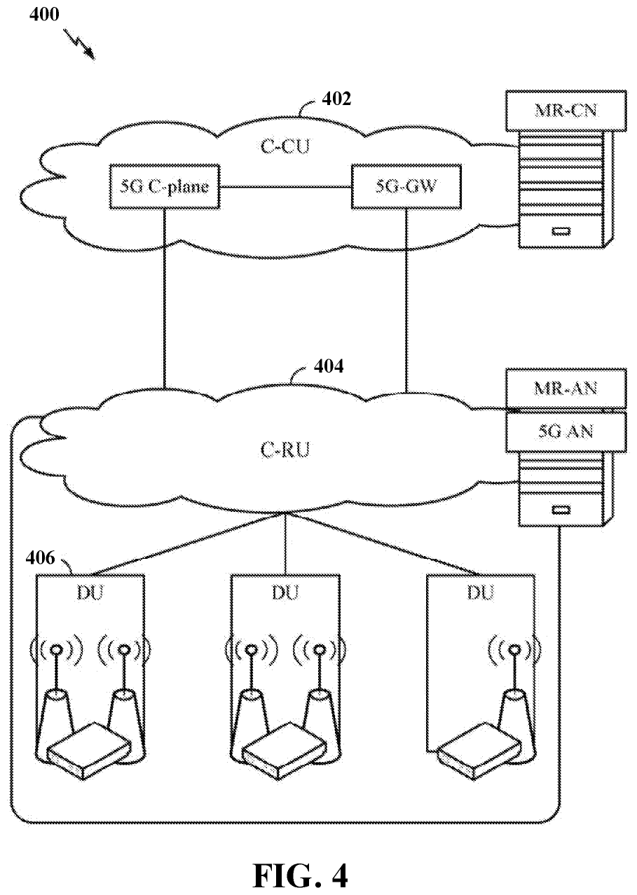

FIG. 4 illustrates an example physical architecture of a distributed RAN 400, according to aspects of the present disclosure. A centralized core network unit (C-CU) 402 may host core network functions. The C-CU may be centrally deployed. C-CU functionality may be offloaded (e.g., to advanced wireless services (AWS)), in an effort to handle peak capacity. A centralized RAN unit (C-RU) 404 may host one or more ANC functions. Optionally, the C-RU may host core network functions locally. The C-RU may have distributed deployment. The C-RU may be closer to the network edge. A distributed unit (DU) 406 may host one or more TRPs. The DU may be located at edges of the network with radio frequency (RF) functionality.

FIG. 5 is a diagram 500 showing an example of a DL-centric slot. The DL-centric slot may include a control portion 502. The control portion 502 may exist in the initial or beginning portion of the DL-centric slot. The control portion 502 may include various scheduling information and/or control information corresponding to various portions of the DL-centric slot. In some configurations, the control portion 502 may be a physical DL control channel (PDCCH), as indicated in FIG. 5. The DL-centric slot may also include a DL data portion 504. The DL data portion 504 may sometimes be referred to as the payload of the DL-centric slot. The DL data portion 504 may include the communication resources utilized to communicate DL data from the scheduling entity (e.g., UE or BS) to the subordinate entity (e.g., UE). In some configurations, the DL data portion 504 may be a physical DL shared channel (PDSCH).

The DL-centric slot may also include a common UL portion 506. The common UL portion 506 may sometimes be referred to as an UL burst, a common UL burst, and/or various other suitable terms. The common UL portion 506 may include feedback information corresponding to various other portions of the DL-centric slot. For example, the common UL portion 506 may include feedback information corresponding to the control portion 502. Non-limiting examples of feedback information may include an ACK signal, a NACK signal, a HARQ indicator, and/or various other suitable types of information. The common UL portion 506 may include additional or alternative information, such as information pertaining to random access channel (RACH) procedures, scheduling requests (SRs), and various other suitable types of information.

As illustrated in FIG. 5, the end of the DL data portion 504 may be separated in time from the beginning of the common UL portion 506. This time separation may sometimes be referred to as a gap, a guard period, a guard interval, and/or various other suitable terms. This separation provides time for the switch-over from DL communication (e.g., reception operation by the subordinate entity (e.g., UE)) to UL communication (e.g., transmission by the subordinate entity (e.g., UE)). One of ordinary skill in the art will understand that the foregoing is merely one example of a DL-centric slot and alternative structures having similar features may exist without necessarily deviating from the aspects described herein.

FIG. 6 is a diagram 600 showing an example of an UL-centric slot. The UL-centric slot may include a control portion 602. The control portion 602 may exist in the initial or beginning portion of the UL-centric slot. The control portion 602 in FIG. 6 may be similar to the control portion 502 described above with reference to FIG. 5. The UL-centric slot may also include an UL data portion 604. The UL data portion 604 may sometimes be referred to as the pay load of the UL-centric slot. The UL portion may refer to the communication resources utilized to communicate UL data from the subordinate entity (e.g., UE) to the scheduling entity (e.g., UE or BS). In some configurations, the control portion 602 may be a physical DL control channel (PDCCH).

As illustrated in FIG. 6, the end of the control portion 602 may be separated in time from the beginning of the UL data portion 604. This time separation may sometimes be referred to as a gap, guard period, guard interval, and/or various other suitable terms. This separation provides time for the switch-over from DL communication (e.g., reception operation by the scheduling entity) to UL communication (e.g., transmission by the scheduling entity). The UL-centric slot may also include a common UL portion 606. The common UL portion 606 in FIG. 6 may be similar to the common UL portion 506 described above with reference to FIG. 5. The common UL portion 606 may additionally or alternatively include information pertaining to channel quality indicator (CQI), sounding reference signals (SRSs), and various other suitable types of information. One of ordinary skill in the art will understand that the foregoing is merely one example of an UL-centric slot and alternative structures having similar features may exist without necessarily deviating from the aspects described herein.

In some circumstances, two or more subordinate entities (e.g., UEs) may communicate with each other using sidelink signals. Real-world applications of such sidelink communications may include public safety, proximity services, UE-to-network relaying, vehicle-to-vehicle (V2V) communications, Internet of Everything (IoE) communications, IoT communications, mission-critical mesh, and/or various other suitable applications. Generally, a sidelink signal may refer to a signal communicated from one subordinate entity (e.g., UE1) to another subordinate entity (e.g., UE2) without relaying that communication through the scheduling entity (e.g., UE or BS), even though the scheduling entity may be utilized for scheduling and/or control purposes. In some examples, the sidelink signals may be communicated using a licensed spectrum (unlike wireless local area networks, which typically use an unlicensed spectrum).

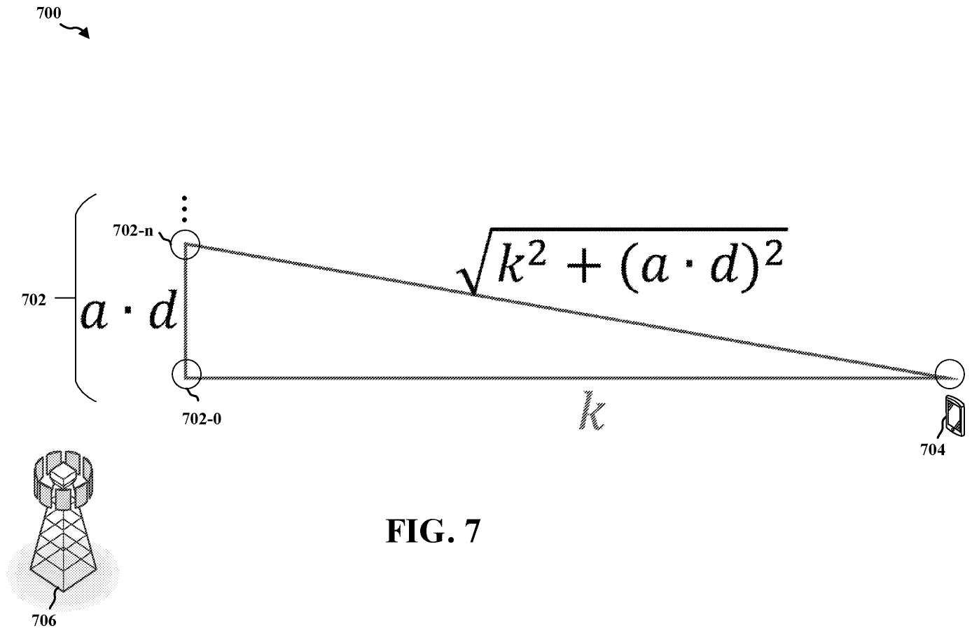

FIG. 7 is a diagram 700 illustrating a simplified spatial arrangement of an antenna array 702 and a UE 704. As a non-limiting example, the antenna array 702 is located in a base station, such as the base station 706, and acts as a transmitter, while the UE 704 acts as a receiver.

The antenna array 702 includes multiple antenna elements arranged linearly along one dimension. Specifically, the array 702 includes a reference antenna 702-0 with an antenna index number of a=0 and multiple additional antennas 702-a, each with an antenna index number a (where a=1, 2, . . . , N−1), and N represents the total number of antennas in the array 702. For example, N=100. Notably, the naming of the reference antenna 702-0 and the additional antennas 702-a is solely for ease of reference and does not imply any functional distinctions among the antennas. The antennas are uniformly spaced, with a spacing of d between each pair of adjacent antennas, where d is equal to half the wavelength, i.e., d=λ/2, and A is the carrier wavelength corresponding to the carrier frequency f_{c}, which may be 7 GHz as an example.

The UE 704 is located at a distance from the antenna array 702. For illustrative purposes, the reference antenna 702-0 (antenna 0), one of the additional antennas 702-a (e.g., antenna 702-1, i.e., a=1), and the UE 704 form a right triangle. In this right triangle, the distance between the UE 704 and the reference antenna 702-0 is denoted as k, forming the adjacent side of the triangle. The antennas in the array 702 are distributed along an axis perpendicular to the line connecting the UE 704 and the reference antenna 702-0, with the distance between the reference antenna 702-0 and any additional antenna 702-a being a×d, where a is the difference in antenna index numbers (i.e., a=1, 2, . . . , N−1). Consequently, the distance between the UE 704 and each additional antenna 702-a forms the hypotenuse of the respective right triangle and is given by:

$${r}_{a} = \sqrt{{k}^{2} + {( a \cdot d )}^{2}}$$

In communication systems utilizing antenna arrays, the superposition of signals transmitted from different antenna elements can enhance the received signal quality at the UE 704 if these signals arrive in-phase. This phenomenon is known as constructive interference. Conversely, if the signals arrive out-of-phase, they can interfere destructively, reducing the combined signal strength at the UE 704.

To achieve constructive interference at the UE 704, the transmitted signals from the different antennas need to be appropriately phase-shifted to compensate for the differences in path lengths from each antenna to the UE 704. The design of the phase shifts (also known as phase compensation) for all elements of the antenna array is referred to as codebook design.

In the far-field scenario, where the distance between the antenna array 702 and the UE 704 is much larger than the array dimensions, the differences in path lengths from the various antenna elements to the UE 704 can be approximated as linearly increasing with the antenna index a. This approximation is valid because, at large distances, the rays from different antennas to the UE 704 are nearly parallel, and the angles of departure from the array to the UE 704 are approximately the same for all antenna elements.

Under the far-field assumption, the phase difference between signals from adjacent antennas is constant, leading to a linear phase ramp across the array. The phase compensation can therefore be modeled as a linear function of the antenna index a:

$${ϕ}_{a}^{FF} = a \cdot {θ}_{H} ,$$

where

$${ϕ}_{a}^{FF}$$

is the phase compensation for antenna a, and θ_{H} is the phase step size between adjacent antennas, determined by the desired beamforming direction. The phase compensation values form a basis vector that can be used in the codebook design for far-field beamforming.

However, in the near-field scenario, where the distance between the antenna array 702 and the UE 704 is relatively small compared to the array dimensions, the far-field approximations no longer hold. Specifically, in the near field, the differences in path lengths from each antenna element to the UE 704 cannot be approximated as linearly increasing with the antenna index a. Instead, the path lengths vary according to the geometry of the configuration, and the phase differences between signals from different antennas are no longer constant.

Referring back to FIG. 7, the distances rₐ from the UE 704 to each antenna 702-a are given by:

$${r}_{a} = \sqrt{{k}^{2} + {( a \cdot d )}^{2}} .$$

These distances can be well approximated by a quadratic function of the antenna index a. The expansion of rₐ in terms of a is shown below:

$${r}_{a} = k {( 1 + {( \frac{a \cdot d}{k} )}^{2} )}^{1 / 2} .$$

For values of a·d that are not negligible compared to k, this expression indicates that rₐ depends quadratically on a. Therefore, the phase differences between the signals from different antennas are not linearly increasing but instead have a quadratic relationship with the antenna index a.

To achieve constructive interference at the UE 704 in the near-field scenario, the phase compensation applied to each antenna must account for the quadratic variation of path lengths with respect to the antenna index a. The phase compensation for antenna a can be modeled as:

$${ϕ}_{a}^{NF} = f ( a ) \cdot {θ}_{H} ,$$

where f(a) is a quadratic polynomial function of a, and θ_{H} is a scaling factor. Specifically, the phase compensation function can be expressed as:

$${ϕ}_{a}^{N F} = ( {c}_{0} + {c}_{1} \cdot a + {c}_{2} \cdot {a}^{2} ) \cdot {θ}_{H} ,$$

where c₀, c₁, and c₂ are coefficients determined based on the geometry and the desired beamforming direction.

In this design, the codebook needs to include phase compensation values that reflect this quadratic dependence on the antenna index a. This represents a departure from the traditional codebook design used in far-field scenarios, which assumes a linear phase ramp across the array. The inclusion of quadratic terms in the phase compensation allows for accurate modeling of the phase variations caused by the varying distances in the near-field scenario.

As an example, consider a system with the following parameters:
Carrier frequency f_{c}=7 GHz, corresponding to a wavelength λ≈0.04286 meters.
Antenna spacing d=λ/2≈0.02143 meters.
Number of antennas N=100.
Antenna indices a=0, 1, 2, . . . , 99.

The propagation distances rₐ for all a can be calculated using the above formula. The phase compensation needed for each antenna can then be determined by computing the phase difference due to the path length difference relative to the reference antenna 702-0:

$$Δ {r}_{a} = {r}_{a} - {r}_{0} = \sqrt{{k}^{2} + {( a \cdot d )}^{2}} - k .$$

The corresponding phase difference (in radians) is:

$$Δ {ϕ}_{a} = \frac{2 π}{λ} Δ {r}_{a} .$$

This phase difference can be approximated by a quadratic function of a:

$$Δ {ϕ}_{a} \approx ( \frac{2 π}{λ} \cdot \frac{{d}^{2}}{2 k} ) {a}^{2} .$$

In the far-field scenario, a·d is small compared to k. However, in the near-field scenario, this assumption may not hold, and higher-order terms may be significant. Therefore, including the quadratic term (and potentially higher-order terms) in the phase compensation function is necessary to accurately model the phase variations.

By incorporating the quadratic phase compensation into the codebook design, the transmitted signals from the antenna array 702 can be appropriately phase-shifted so that they arrive at the UE 704 in-phase, even in near-field scenarios where the path length differences are not linearly increasing. This improves the signal quality at the UE 704 by maximizing constructive interference.

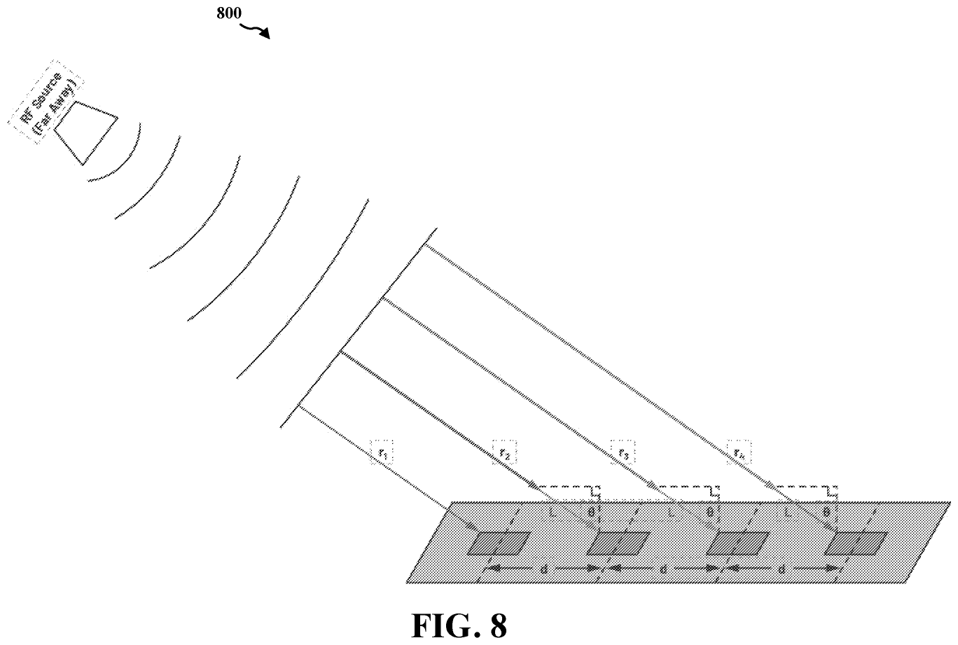

FIG. 8 is a diagram 800 illustrating the path length differences between a RF source and various antenna elements in an antenna array within a far-field scenario. The diagram depicts a simplified representation of the spatial arrangement between a transmitting RF source and a receiving antenna array.

In one far-field scenario, the RF source and the antenna array are positioned at a considerable distance from each other. This distance is typically greater than 2D²/λ, where D represents the diameter of the antenna array and λ is the wavelength of the transmitted signal. For a uniformly spaced linear array, such as the one shown in FIG. 8, D can be expressed as (N−1)×d, where N is the number of antenna elements and d is the spacing between adjacent elements.

The far-field condition can be mathematically expressed as Equation (1) below:

$$Far Field Distance > \frac{2 {D}^{2}}{λ} . \qquad ( 1 )$$

Under this condition, the wavefront of the transmitted signal can be approximated as planar when it reaches the antenna array. Consequently, the signals received by the N antennas in the array (in this case, N=4) can be considered to arrive parallel to each antenna element, with the same angle of incidence θ to the normal direction of the antenna array.

In FIG. 8, the path lengths from the wavefront to the first, second, third, and fourth antenna elements are denoted as r₁, r₂, r₃, and r₄, respectively. Due to the far-field approximation, these path lengths exhibit a linear relationship:

$${r}_{2} = {r}_{1} + L , {r}_{3} = {r}_{1} + 2 L , {r}_{4} = {r}_{1} + 3 L ,$$

where L represents the path length difference between two adjacent antenna elements. This path length difference L is related to the antenna spacing d and the angle of incidence θ by:

$$L = d sin θ ,$$

The phase difference ΔΦ between signals received by adjacent antenna elements is directly proportional to the path length difference L:

$$Δ Φ = \frac{2 π L}{λ} .$$

For the common case where the antenna spacing d is equal to half the wavelength λ/2, the phase difference simplifies to:

$$Δ Φ = π sin θ .$$

This linear increase in phase difference across the antenna array is a characteristic of far-field scenarios. It results in a constant phase progression from one antenna element to the next, which can be expressed as ΔΦ, 2ΔΦ, 3ΔΦ, and so on for successive antenna elements.

The linear phase progression in far-field scenarios forms the basis for beamforming techniques and codebook designs. As described supra, the phase compensation applied to each antenna element is typically modeled as a linear function of the antenna index a:

$${ϕ}_{a}^{F F} = a \cdot {θ}_{H} ,$$

where

$${ϕ}_{a}^{F F}$$

is the phase compensation for antenna a, and θ_{H} is the phase step size between adjacent antennas, determined by the desired beamforming direction.

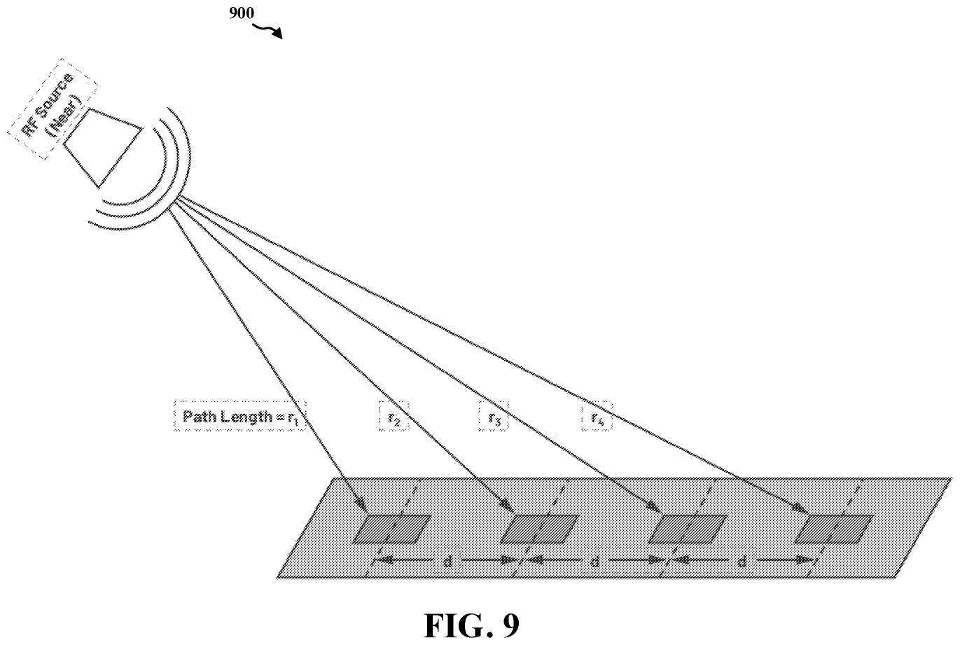

FIG. 9 is a diagram 900 illustrating the path length differences between an RF source and various antenna elements in an antenna array within a Near Field scenario. Unlike the Far Field scenario depicted in FIG. 8, the Near Field scenario in FIG. 9 shows that the paths from the RF source to different antenna elements have varying angles with respect to the normal direction of the antenna array. This results in non-uniform path length differences between adjacent antenna elements, leading to nonlinearly increasing phase differences.

The distinction between Near Field and Far Field scenarios is determined by a distance threshold, which is dependent on the wavelength λ, as shown in Equation (1). Given that the frequency f is related to the wavelength by f=c/λ, where c is the speed of light, an increase in carrier frequency, for example, above 7 GHz, expands the distance threshold. This expansion increases the likelihood of encountering Near Field conditions in practical scenarios.

Furthermore, at frequencies above 7 GHz, the spacing between antenna elements can be reduced, allowing for a greater number of elements to be arranged in an antenna array. This reduction in element spacing, coupled with the possibility of increasing the overall size of the antenna array, contributes to a larger value of D in Equation (1). For instance, a Reconfigurable Intelligent Surface (RIS) can comprise a large antenna panel, significantly increasing the value of D. The larger the entire panel area, the more pronounced the Near Field effects become, further necessitating the consideration of Near Field conditions in system design.

In the Near Field scenario, the codebook design at the transmitter must account for the nonlinear path length differences to enable constructive interference at the receiver. Referring back to FIG. 7, the distance from the reference antenna 702-0 to the UE 704 is denoted as k. For an additional antenna 702-a, where a is the antenna index, the distance to the UE 704 is given by \sqrt{k²+(a·d)²}, where d is the antenna spacing. To achieve constructive interference, a phase difference must be applied to the additional antenna 702-a to compensate for the path length difference \sqrt{k²+(a·d)²}−k.

This phase compensation can be modeled as a function of the antenna index a. As discussed earlier, in the Near Field scenario, the phase compensation is more accurately represented by a quadratic function rather than a linear function. The phase compensation for antenna a can be expressed as:

$${ϕ}_{a}^{N F} = ( {c}_{0} + {c}_{1} \cdot a + {c}_{2} \cdot {a}^{2} ) \cdot {θ}_{H} ,$$

where c₀, c₁, and c₂ are coefficients determined based on the geometry and the desired beamforming direction, and θ_{H} is a scaling factor.

The codebook design for the Near Field scenario may incorporate this quadratic phase compensation to accurately model the phase variations caused by the nonlinear path length differences. This approach represents a significant departure from the traditional Far Field codebook design, which assumes a linear phase ramp across the array.

In FIG. 9, the RF source is depicted as being closer to the antenna array compared to FIG. 8. The antenna array in FIG. 9 includes multiple antenna elements, labeled with path lengths r₁, r₂, r₃, and r₄. Unlike in the Far Field scenario, these path lengths do not exhibit a linear relationship. Instead, they follow a nonlinear progression that can be approximated by a quadratic function.

The nonlinear nature of the path length differences in the Near Field scenario necessitates a more complex codebook design. The UE reports parameters that allow the base station to reconstruct the appropriate phase compensation for each antenna element. These parameters may include the coefficients c₀, c₁, and c₂ of the quadratic function, as well as the scaling factor θ_{H}.

The Near Field codebook design can be viewed as a generalization of the Far Field design. By setting the quadratic coefficient c₂ to zero, the phase compensation function reduces to a linear function, which is suitable for Far Field scenarios. This flexibility allows the codebook design to adapt to varying propagation conditions, from Near Field to Far Field, without changing the fundamental structure of the codebook.

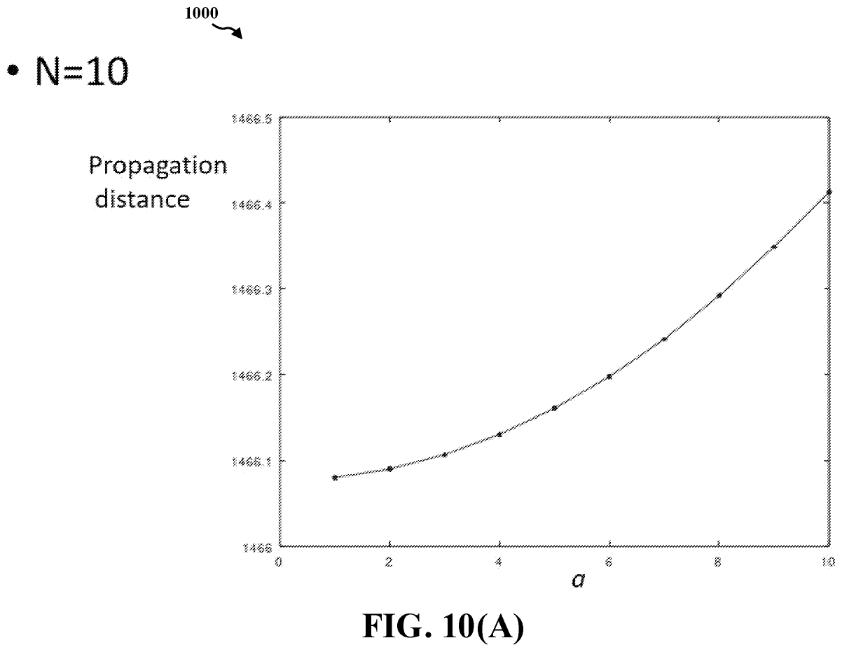

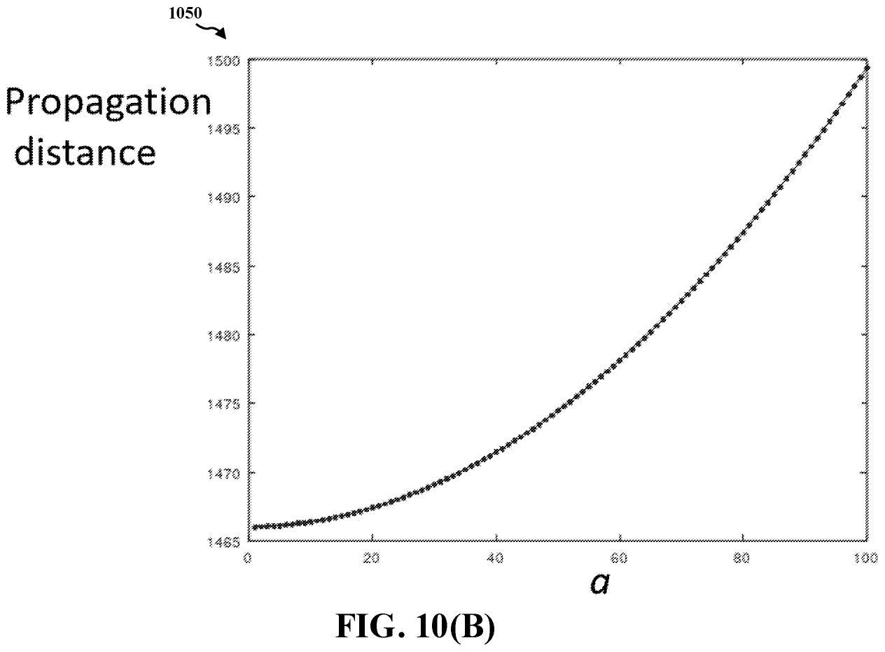

FIG. 10(A) is a diagram 1000 illustrating the relationship between the propagation distance from various antennas to a UE and the difference in index numbers between a reference antenna and an additional antenna “a”, where the total number of antennas N=10. The horizontal axis represents the antenna index “a”, ranging from 0 to 9, while the vertical axis represents the propagation distance. The graph shows a smooth, increasing curve that resembles a quadratic function.

The propagation distance plotted in FIG. 10(A) corresponds to the distance rₐ described in FIG. 8, which is given by the equation:

$${r}_{a} = \sqrt{{k}^{2} + {( a \cdot d )}^{2}} ,$$

where k is the distance between the UE and the reference antenna, a is the antenna index, and d is the spacing between adjacent antennas. The curve in FIG. 10(A) demonstrates that the propagation distance increases non-linearly with the antenna index, supporting the assertion that a quadratic function can well approximate this relationship in the Near Field scenario.

FIG. 10(B) is a diagram 1050 depicting a similar relationship as FIG. 10(A), but for a larger antenna array where the total number of antennas N=100. The horizontal axis now extends from 0 to 99, representing the antenna indices for this larger array. The vertical axis again represents the propagation distance.

The curve in FIG. 10(B) exhibits a more pronounced quadratic shape compared to FIG. 10(A). This is due to the larger number of antennas and the consequently wider range of antenna indices. The increased curvature in FIG. 10(B) further shows the non-linear nature of the propagation distance in the Near Field scenario.

Both FIG. 10(A) and FIG. 10(B) illustrate the key difference between the Near Field and Far Field scenarios. In the Far Field scenario, as discussed in relation to FIG. 8, the path length differences between adjacent antennas would be approximately constant, resulting in a linear relationship between the antenna index and the propagation distance. However, the curves in FIG. 10(A) and FIG. 10(B) deviate from linearity, especially for larger antenna indices, indicating the Near Field effects.

In wireless communication systems, in certain scenarios, codebook designs have been optimized for far-field scenarios, where the distance between the transmitting antenna array and the receiving User Equipment (UE) is significantly larger than the dimensions of the antenna array. However, with the advent of higher frequency communications, such as those above 7 GHz, and the increasing use of large antenna arrays, near-field scenarios are becoming more prevalent. This section explores the challenges and proposed solutions for codebook design in near-field communication scenarios.

In far-field scenarios, the path length differences between signals from adjacent antenna elements to the UE can be approximated as linearly increasing. This approximation allows for a simplified codebook design where the phase compensation for each antenna element follows a linear progression. Specifically, for a one-dimensional (1D) antenna array with N elements, the basis vector for phase compensation can be represented as [1, e^{jθ}, e^{j2θ}, . . . , e^{j(N-1)θ}], where θ represents the phase difference between adjacent elements.

For two-dimensional (2D) antenna arrays, which are common in modern base stations, the codebook design extends to account for both horizontal and vertical dimensions. The 2D-DFT (Discrete Fourier Transform) oversampling basis, widely used in current systems, is constructed as the Kronecker product of two 1D basis vectors. Each 1D basis vector represents the phase compensation for one dimension (horizontal or vertical) and exhibits a constant phase ramping.

The 2D-DFT oversampling basis can be expressed as the Kronecker product of the following two 1D basis vectors:

$$[ \begin{matrix}1 \\ {e}^{j {θ}_{H}} \\ {e}^{j 2 {θ}_{H}} \\ ⋮ \\ {e}^{j a {θ}_{H}} \\ ⋮ \\ {e}^{j ( {N}_{1} - 1 ) {θ}_{H}}\end{matrix} ] ⊗ [ \begin{matrix}1 \\ {e}^{j {θ}_{V}} \\ {e}^{j 2 {θ}_{V}} \\ ⋮ \\ {e}^{jb {θ}_{V}} \\ ⋮ \\ {e}^{j ( {N}_{2} - 1 ) {θ}_{V}}\end{matrix} ] .$$

Here, θ_{H} and θ_{V} represent the phase step sizes or the horizontal and vertical dimensions, respectively. N₁ and N₂ are the number of antenna elements in the horizontal and vertical dimensions, a is the antenna element index in the horizontal dimension, and b is the antenna element index in the vertical dimension.

However, in near-field scenarios, the linear approximation of path length differences no longer holds. As illustrated in FIG. 9, the path lengths from the RF source to different antenna elements vary non-uniformly, resulting in nonlinearly increasing phase differences. This nonlinear relationship is further demonstrated in FIG. 10(A) and FIG. 10(B), which show the propagation distance as a function of antenna index for arrays with 10 and 100 elements, respectively.

To address this nonlinear behavior in near-field scenarios, a novel approach to construct the spatial basis using a quadratic polynomial may be used. Unlike the 2D-DFT oversampling basis that uses a linear function, in the near-field scenario, the 2D-DFT oversampling basis is constructed as the Kronecker product of two 1D basis vectors, each of which has a ramping phase modeled by a quadratic function.

In this quadratic model, taking the horizontal dimension as an example, the phase ramping is modeled by a quadratic function:

$${y}_{H} = ( {c}_{0} + a + c \cdot {a}^{2} ) \cdot {θ}_{H} = f ( a ) \cdot {θ}_{H} ,$$

where a is the antenna element index along the horizontal dimension, f(a) is a polynomial of a, c is a quadratic coefficient in the horizontal dimension, c₀ is a constant in the horizontal dimension, and θ_{H} is the phase step size in the horizontal dimension.

Similarly, the phase ramping in the vertical dimension is modeled by a quadratic function:

$${y}_{V} = ( {d}_{0} + b + d \cdot {b}^{2} ) \cdot {θ}_{V} = g ( b ) \cdot {θ}_{V} ,$$

where b is the antenna element index along the vertical dimension, g(b) is a polynomial of b, d is a quadratic coefficient in the vertical dimension, d₀ is a constant in the vertical dimension, and θ_{V} is the phase step size in the vertical dimension.

The spatial basis for the near-field codebook, which uses the quadratic function, can be constructed as the Kronecker product of the following two 1D basis vectors:

$$[ \begin{matrix}1 \\ {e}^{j ( {c}_{0} + 1 + c ) {θ}_{H}} \\ {e}^{j ( {c}_{0} + 2 + c \cdot {2}^{2} ) {θ}_{H}} \\ ⋮ \\ {e}^{j ( {c}_{0} + a + c \cdot {a}^{2} ) {θ}_{H}} \\ ⋮ \\ {e}^{j ( {c}_{0} + ( {N}_{1} - 1 ) + c \cdot {( {N}_{1} - 1 )}^{2} ) {θ}_{H}}\end{matrix} ] ⊗ [ \begin{matrix}1 \\ {e}^{j ( {d}_{0} + 1 + d ) {θ}_{V}} \\ {e}^{j ( {d}_{0} + 2 + d \cdot {2}^{2} ) {θ}_{V}} \\ ⋮ \\ {e}^{j ( {d}_{0} + b + d \cdot {b}^{2} ) {θ}_{V}} \\ ⋮ \\ {e}^{j ( {d}_{0} + ( {N}_{2} - 1 ) + d \cdot {( {N}_{2} - 1 )}^{2} ) {θ}_{V}}\end{matrix} ] .$$

It is important to note that in this formulation, the linear coefficient in the quadratic function is set to 1 for simplicity. However, in a more general form, the quadratic function may have a coefficient set including three coefficients: c₀, c₁, and c₂ for y_{H}=(c₀+c₁a+c₂a²)·θ_{H}. Furthermore, any one of these three coefficients can be normalized to 1 for simplicity, resulting in equivalent forms such as:

$${y}_{H} = ( 1 + {c}_{1}^{′} a + {c}_{2}^{′} \cdot {a}^{2} ) \cdot {θ}_{H}^{′} ,$$

$${y}_{H} = ( {c}_{0}^{′} + a + {c}_{2}^{′} \cdot {a}^{2} ) \cdot {θ}_{H}^{′} ,$$

$${y}_{H} = ( {c}_{0}^{′} + {c}_{1}^{′} a + {a}^{2} ) \cdot {θ}_{H}^{′} .$$

All these forms are equivalent and involve a quadratic expression of the variable a.

To apply this quadratic model in practice, a UE, such as the UE 704 shown in FIG. 7, needs to report a parameter set to a base station, such as the base station 706. These parameters describe the quadratic function and indicate how to adjust the transmitter's phase to promote constructive interference of the received signal. The UE 704 may use channel state information (CSI) feedback to convey these parameters, which may include c₀′, c, θ_{H}, d₀, d, and θ_{V} as shown in the basis vectors above, or quantized version of them.

For the general form, regardless of which normalization method is applied, the CSI needs to specify three parameters for each 1D basis. For example, if using the form y_{H}=(c₀′+c₁′a+a²)·θ_{H}′, the UE 704 would need to report c₀′, c₁′, and θ_{H}′ for the horizontal dimension, and similarly for the vertical dimension.

Once the UE 704 provides these necessary parameters, the base station 706 can independently construct the entire vector representing the spatial basis. This approach allows for accurate modeling of the phase variations caused by the nonlinear path length differences in near-field scenarios.

This quadratic model can fall back to a linear model by setting the quadratic coefficients c=0 and d=0. This flexibility allows the codebook design to adapt to varying propagation conditions, from near-field to far-field, without changing the fundamental structure of the codebook.

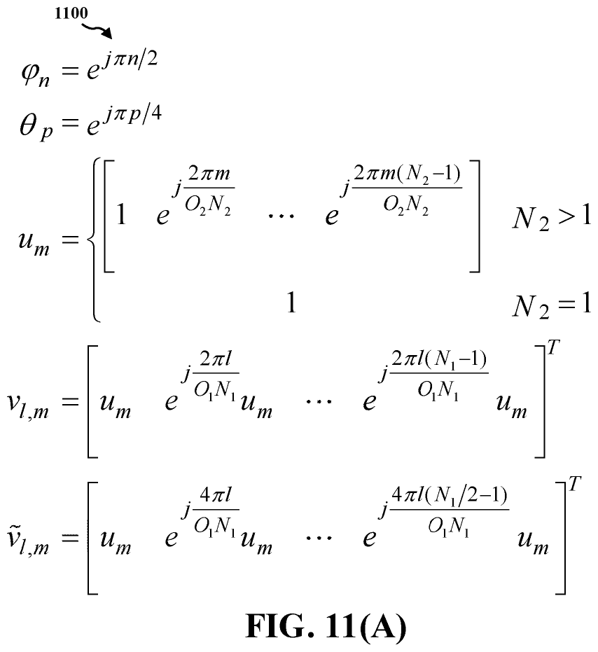

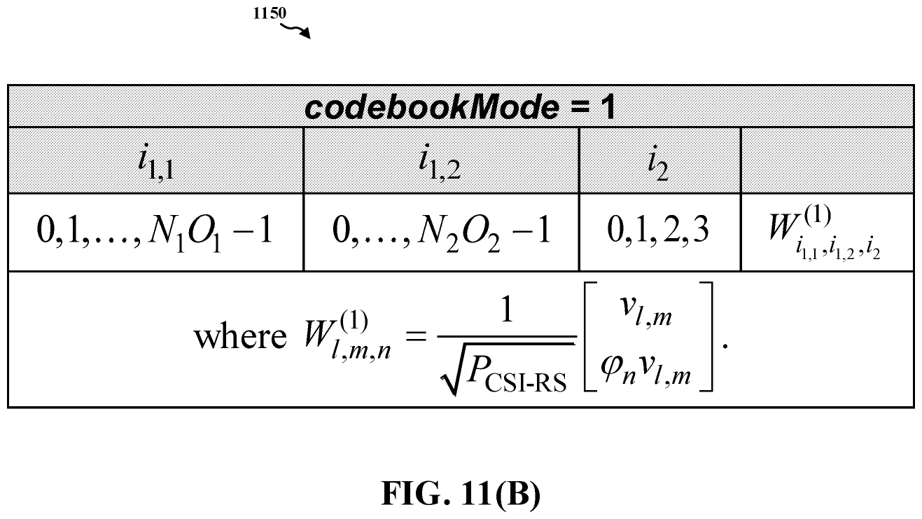

FIG. 11(A) is a diagram 1100 illustrating an example basis defined in a NR codebook. FIG. 11(B) is a table 1150 illustrating a codebook for 1-layer CSI reporting.

The codebook design for near-field communication scenarios can be further refined by incorporating quadratic phase compensation. This approach builds upon the concepts introduced in the NR codebook and extends them to address the unique challenges posed by near-field propagation.

In the near-field scenario, the precoding vectors can be constructed using a form similar to that of the NR codebook, but with modifications to account for the quadratic phase variations. The precoding vector v_{l,m} is formed as the Kronecker product of two 1D basis vectors, each incorporating quadratic phase compensation. The structure of these basis vectors is as follows:

$${u}_{m} = [ \begin{matrix}1 \\ {e}^{j ( {c}_{0} + 1 + c ) {θ}_{H}} \\ {e}^{j ( {c}_{0} + 2 + c \cdot {2}^{2} ) {θ}_{H}} \\ ⋮ \\ {e}^{j ( {c}_{0} + m + c \cdot {m}^{2} ) {θ}_{H}} \\ ⋮ \\ {e}^{j ( {c}_{0} + ( {N}_{1} - 1 ) + c \cdot {( {N}_{1} - 1 )}^{2} ) {θ}_{H}}\end{matrix} ] ,$$

$${v}_{l , m} = [ \begin{matrix}1 \\ {e}^{j ( {d}_{0} + 1 + d ) {θ}_{V}} \cdot {u}_{m} \\ {e}^{j ( {d}_{0} + 2 + d \cdot {2}^{2} ) {θ}_{V}} \cdot {u}_{m} \\ ⋮ \\ {e}^{j ( {d}_{0} + l + d \cdot {l}^{2} ) {θ}_{V}} \cdot {u}_{m} \\ ⋮ \\ {e}^{j ( {d}_{0} + ( {N}_{2} - 1 ) + d \cdot {( {N}_{2} - 1 )}^{2} ) {θ}_{V}} \cdot {u}_{m}\end{matrix} ] .$$

In these expressions, c₀, c, θ_{H}, d₀, d, and θ_{V} are parameters that define the quadratic phase compensation for the horizontal and vertical dimensions, respectively. The indices m and l correspond to the antenna elements in the horizontal and vertical directions, while N₁ and N₂ represent the total number of antenna elements in each dimension.

The quadratic terms (c·m²) and (d·l²) in the exponents account for the nonlinear phase variations observed in near-field scenarios, as illustrated in FIG. 9 and FIGS. 10(A) and (B). These terms allow for more accurate modeling of the phase differences between antenna elements, which deviate from the linear progression assumed in far-field scenarios.

To accommodate dual polarization, which is common in modern antenna arrays, the codebook can be extended further. The precoding matrix W_{l,m,n} for dual polarization can be expressed as:

$${W}_{l , m , n} = α [ \begin{matrix}{v}_{l , m} \\ {ϕ}_{n} \cdot {v}_{l , m}\end{matrix} ] ,$$

where α is a scaling factor, and φₙ=e^{j2πn} represents the phase difference between the two polarization directions. The upper half of W_{l,m,n} corresponds to antennas with one polarization direction, while the lower half corresponds to antennas with another polarization direction. It is worth noting that these two polarization directions can be the same if required by the system design.

This codebook structure allows for flexible adaptation to various near-field scenarios. By adjusting the parameters c₀, c, d₀, d, θ_{H}, and θ_{V}, the codebook can be optimized for different antenna array configurations and propagation environments. For instance, in scenarios where the UE 704 is very close to the base station 706, the quadratic terms may have a more significant impact, requiring larger values for c and d. Conversely, as the UE 704 moves farther from the base station 706, approaching far-field conditions, the quadratic terms can be reduced, effectively reverting to a more linear phase progression.

To implement this codebook design in practice, a UE 704 may estimate the channel state information and determine the optimal values for the parameters c₀, c, d₀, d, θ_{H}, and θ_{V}. These parameters would then be reported back to the base station 706 as part of the CSI feedback. The base station 706 would use this information to construct the appropriate precoding vectors and matrices for transmission.

Furthermore, this codebook design can be extended to accommodate even higher-order polynomial approximations if needed. For example, in extreme near-field scenarios or with very large antenna arrays, cubic or higher-order terms could be included in the phase compensation to achieve even greater accuracy. However, the quadratic approximation presented here strikes a balance between improved accuracy and manageable complexity for most practical near-field scenarios.

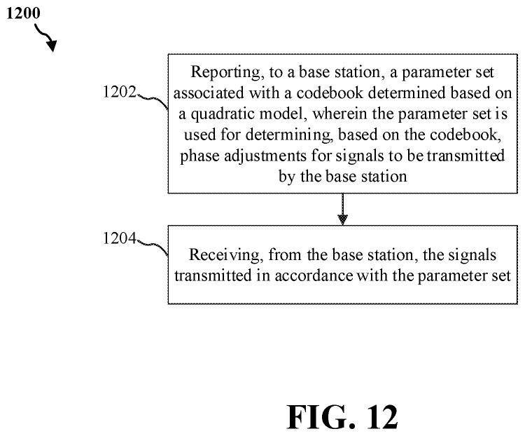

FIG. 12 illustrates a flow chart 1200 of a process for near-field communication based on a codebook. This process may be performed on a UE (e.g., the UE 704).

At block 1202, the UE 704 may report, to a base station (e.g., the base station 706), a parameter set associated with a codebook determined based on a quadratic model. The parameter set may be used for determining, based on the codebook, phase adjustments for signals to be transmitted by the base station 706.

At block 1204, the UE 704 may receive, from the base station 706, the signals transmitted in accordance with the parameter set.

In some embodiments, the parameter set may include: a coefficient set of the quadratic model; and a step size for a phase change unit between adjacent antenna elements in an antenna array within the base station, the antenna array being used to transmit the signals.

In some embodiments, the coefficient set may be used to determine scaling factors applied to the step size to obtain the phase adjustments.

In some embodiments, the antenna array may include a two-dimensional (2D) antenna array. In some embodiments, the coefficient set may include a first coefficient set of a quadratic polynomial for a first dimension and a second coefficient set of a quadratic polynomial for a second dimension; and the step size may include a first step size for a phase change between adjacent antenna elements in the first dimension and a second step size for a phase change between adjacent antenna elements in the second dimension. For example, the first dimension may be the horizontal dimension, and the second dimension may be the vertical dimension.

In some embodiments, the coefficient set may include a quadratic coefficient, a linear coefficient and a constant, and any one of the quadratic coefficient, the linear coefficient and the constant may be normalized to 1.

In some embodiments, reporting the parameter set may include transmitting the parameter set through a channel state information (CSI) feedback to the base station.

In some embodiments, the codebook may be constructed as a Kronecker product of two one-dimensional (1D) basis vectors represented as:

$$[ \begin{matrix}1 \\ {e}^{j ( {c}_{0} + 1 + c ) {θ}_{H}} \\ {e}^{j ( {c}_{0} + 2 + c \cdot {2}^{2} ) {θ}_{H}} \\ ⋮ \\ {e}^{j ( {c}_{0} + a + c \cdot {a}^{2} ) {θ}_{H}} \\ ⋮ \\ {e}^{j ( {c}_{0} + ( {N}_{1} - 1 ) + c \cdot {( {N}_{1} - 1 )}^{2} ) {θ}_{H}}\end{matrix} ] ⊗ [ \begin{matrix}1 \\ {e}^{j ( {d}_{0} + 1 + d ) {θ}_{V}} \\ {e}^{j ( {d}_{0} + 2 + d \cdot {2}^{2} ) {θ}_{V}} \\ ⋮ \\ {e}^{j ( {d}_{0} + b + d \cdot {b}^{2} ) {θ}_{V}} \\ ⋮ \\ {e}^{j ( {d}_{0} + ( {N}_{2} - 1 ) + d \cdot {( {N}_{2} - 1 )}^{2} ) {θ}_{V}}\end{matrix} ]$$

where:
   a is an antenna element index along a first dimension in the antenna array within the base station;
   b is an antenna element index along a second dimension in the antenna array within the base station;
   θ_{H} is a step size for a phase change between adjacent antenna elements in the antenna array in the first dimension;
   θ_{V} is a step size for a phase change between adjacent antenna elements in the antenna array in the second dimension;
   N₁ is the total number of antennas in the antenna array in the first dimension;
   N₂ is the total number of antennas in the antenna array in the second dimension;
   c₀ is a constant of a quadratic polynomial in the first dimension;
   c is a quadratic coefficient of the quadratic polynomial in the first dimension;
   d₀ is a constant of a quadratic polynomial in the second dimension; and
   d is a quadratic coefficient of the quadratic polynomial in the second dimension.

In some embodiments, the phase of each signal in the signals using the quadratic model may be represented by:

$$y = ( {c}_{0} + {c}_{1} a + {c}_{2} \cdot {a}^{2} ) \cdot {θ}_{H}$$

where:
a is an antenna element index in an antenna array within the base station;
θ_{H} is a step size for a phase change between adjacent antenna elements in the antenna array; and
c₀, c₁, and c₂ are a constant, a linear coefficient, and a quadratic coefficient of a quadratic polynomial, respectively.

In some embodiments, after any one of the quadratic coefficient, the linear coefficient and the constant is normalized to 1, the phase of each signal in the signals using the quadratic model may be equivalently represented by one of:

$$y = ( 1 + {c}_{1}^{′} a + {c}_{2}^{′} \cdot {a}^{2} ) \cdot {θ}_{H}^{′}$$

$$y = ( {c}_{0}^{′} + a + {c}_{2}^{′} \cdot {a}^{2} ) \cdot {θ}_{H}^{′}$$

$$y = ( {c}_{0}^{′} + {c}_{1}^{′} a + {a}^{2} ) \cdot {θ}_{H}^{′} .$$

In some embodiments, the codebook may be constructed in the following form:

$${u}_{m} = [ \begin{matrix}1 \\ {e}^{j ( {c}_{0} + 1 + c ) {θ}_{H}} \\ {e}^{j ( {c}_{0} + 2 + c \cdot {2}^{2} ) {θ}_{H}} \\ ⋮ \\ {e}^{j ( {c}_{0} + m + c \cdot {m}^{2} ) {θ}_{H}} \\ ⋮ \\ {e}^{j ( {c}_{0} + ( {N}_{1} - 1 ) + c \cdot {( {N}_{1} - 1 )}^{2} ) {θ}_{H}}\end{matrix} ]$$

$${v}_{l , m} = [ \begin{matrix}{u}_{m} \\ {e}^{j ( {d}_{0} + 1 + d ) {θ}_{V}} \cdot {u}_{m} \\ {e}^{j ( {d}_{0} + 2 + d \cdot {2}^{2} ) {θ}_{V}} \cdot {u}_{m} \\ ⋮ \\ {e}^{j ( {d}_{0} + l + d \cdot {l}^{2} ) {θ}_{V}} \cdot {u}_{m} \\ ⋮ \\ {e}^{j ( {d}_{0} + ( {N}_{2} - 1 ) + d \cdot {( {N}_{2} - 1 )}^{2} ) {θ}_{V}} \cdot {u}_{m}\end{matrix} ]$$

where v_{l,m} is a Kronecker product of two one-dimensional (1D) basis vectors, uₘ is a 1D basis vector; and
   m is an antenna element index along a first dimension in an antenna array within the base station;
   l is an antenna element index along a second dimension in the antenna array within the base station;
   θ_{H} is a step size for a phase change between adjacent antenna elements in the antenna array in the first dimension;
   θ_{V} is a step size for a phase change between adjacent antenna elements in the antenna array in the second dimension;
   N₁ is the total number of antennas in the antenna array in the first dimension;
   N₂ is the total number of antennas in the antenna array in the second dimension;
   c₀ is a constant of a quadratic polynomial in the first dimension;
   c is a quadratic coefficient of the quadratic polynomial in the first dimension;
   d₀ is a constant of a quadratic polynomial in the second dimension; and
d is a quadratic coefficient of the quadratic polynomial in the second dimension.

In some embodiments, when antennas in the antenna array have dual polarization directions, the codebook may be extended and described in the following form:

$${W}_{l , m , n} = α [ \begin{matrix}{v}_{l , m} \\ {ϕ}_{n} \cdot {v}_{l , m}\end{matrix} ] ; {ϕ}_{n} = {e}^{j 2 π n}$$

where α is a scaling factor, an upper half of W_{l,m,n} corresponds to antennas with one polarization direction, while a lower half of W_{l,m,n} corresponds to antennas with another polarization direction. In some embodiments, the dual polarization directions may be the same.

It is understood that the specific order or hierarchy of blocks in the processes/flowcharts disclosed is an illustration of exemplary approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

What is claimed is:

1. A method of wireless communication of a user equipment (UE), comprising:
reporting, to a base station, a parameter set associated with a codebook determined based on a quadratic model, wherein the parameter set is used for determining, based on the codebook, phase adjustments for signals to be transmitted by the base station; and
receiving, from the base station, the signals transmitted in accordance with the parameter set.

2. The method of claim 1, wherein the parameter set comprises:
a coefficient set of the quadratic model; and
a step size for a phase change unit between adjacent antenna elements in an antenna array within the base station, the antenna array being used to transmit the signals.

3. The method of claim 2, wherein the coefficient set is used to determine scaling factors applied to the step size to obtain the phase adjustments.

4. The method of claim 2, wherein the antenna array comprises a two-dimensional (2D) antenna array.

5. The method of claim 4, wherein:
the coefficient set comprises a first coefficient set of a quadratic polynomial for a first dimension and a second coefficient set of a quadratic polynomial for a second dimension; and
the step size comprises a first step size for a phase change between adjacent antenna elements in the first dimension and a second step size for a phase change between adjacent antenna elements in the second dimension.

6. The method of claim 2, wherein the coefficient set comprises a quadratic coefficient, a linear coefficient and a constant, and wherein any one of the quadratic coefficient, the linear coefficient and the constant is normalized to 1.

7. The method of claim 1, wherein reporting the parameter set comprises transmitting the parameter set through a channel state information (CSI) feedback to the base station.

8. The method of claim 1, wherein the codebook is constructed as a Kronecker product of two one-dimensional (1D) basis vectors represented as:
$$[ \begin{matrix}1 \\ {e}^{j ( {c}_{0} + 1 + c ) {θ}_{H}} \\ {e}^{j ( {c}_{0} + 2 + c \cdot {2}^{2} ) {θ}_{H}} \\ ⋮ \\ {e}^{j ( {c}_{0} + a + c \cdot {a}^{2} ) {θ}_{H}} \\ ⋮ \\ {e}^{j ( {c}_{0} + ( {N}_{1} - 1 ) + c \cdot {( {N}_{1} - 1 )}^{2} ) {θ}_{H}}\end{matrix} ] ⊗ [ \begin{matrix}1 \\ {e}^{j ( {d}_{0} + 1 + d ) {θ}_{V}} \\ {e}^{j ( {d}_{0} + 2 + d \cdot {2}^{2} ) {θ}_{V}} \\ ⋮ \\ {e}^{j ( {d}_{0} + b + d \cdot {ab}^{2} ) {θ}_{V}} \\ ⋮ \\ {e}^{j ( {d}_{0} + ( {N}_{2} - 1 ) + d \cdot {( {N}_{2} - 1 )}^{2} ) {θ}_{V}}\end{matrix} ]$$
where:
a is an antenna element index along a first dimension in an antenna array within the base station;
b is an antenna element index along a second dimension in the antenna array within the base station;
θ_{H} is a step size for a phase change between adjacent antenna elements in the antenna array in the first dimension;
θ_{V} is a step size for a phase change between adjacent antenna elements in the antenna array in the second dimension;
N₁ is the total number of antennas in the antenna array in the first dimension;
N₂ is the total number of antennas in the antenna array in the second dimension;
c₀ is a constant of a quadratic polynomial in the first dimension;
c is a quadratic coefficient of the quadratic polynomial in the first dimension;
d₀ is a constant of a quadratic polynomial in the second dimension; and
d is a quadratic coefficient of the quadratic polynomial in the second dimension.

9. The method of claim 1, wherein a phase of each signal in the signals using the quadratic model is represented by:
$$y = ( {c}_{0} + {c}_{1} a + {c}_{2} \cdot {a}^{2} ) \cdot {θ}_{H}$$
where:
a is an antenna element index in an antenna array within the base station;
θ_{H} is a step size for a phase change between adjacent antenna elements in the antenna array; and
c₀, c₁, and c₂ are a constant, a linear coefficient, and a quadratic coefficient of a quadratic polynomial, respectively.

10. The method of claim 9, wherein after any one of the quadratic coefficient, the linear coefficient and the constant is normalized to 1, the phase of each signal in the signals using the quadratic model is equivalently represented by one of:
$$y = ( 1 + {c}_{1}^{′} a + {c}_{2}^{′} \cdot {a}^{2} ) \cdot {θ}_{H}^{′}$$
$$y = ( {c}_{0}^{′} + a + {c}_{2}^{′} \cdot {a}^{2} ) \cdot {θ}_{H}^{′}$$
$$y = ( {c}_{0}^{′} + {c}_{1}^{′} a + {a}^{2} ) \cdot {θ}_{H}^{′} .$$

11. The method of claim 1, wherein the codebook is constructed in the following form:
$${u}_{m} = [ \begin{matrix}1 \\ {e}^{j ( {c}_{0} + 1 + c ) {θ}_{H}} \\ {e}^{j ( {c}_{0} + 2 + c \cdot {2}^{2} ) {θ}_{H}} \\ ⋮ \\ {e}^{j ( {c}_{0} + m + c \cdot {m}^{2} ) {θ}_{H}} \\ ⋮ \\ {e}^{j ( {c}_{0} + ( {N}_{1} - 1 ) + c \cdot {( {N}_{1} - 1 )}^{2} ) {θ}_{H}}\end{matrix} ]$$
$${v}_{l , m} = [ \begin{matrix}{u}_{m} \\ {e}^{j ( {d}_{0} + 1 + d ) {θ}_{V}} \cdot {u}_{m} \\ {e}^{j ( {d}_{0} + 2 + d \cdot {2}^{2} ) {θ}_{V}} \cdot {u}_{m} \\ ⋮ \\ {e}^{j ( {d}_{0} + l + d \cdot {l}^{2} ) {θ}_{V}} \cdot {u}_{m} \\ ⋮ \\ {e}^{j ( {d}_{0} + ( {N}_{2} - 1 ) + d \cdot {( {N}_{2} - 1 )}^{2} ) {θ}_{V}} \cdot {u}_{m}\end{matrix} ]$$
where v_{l,m} is a Kronecker product of two one-dimensional (1D) basis vectors, uₘ is a 1D basis vector, and
m is an antenna element index along a first dimension in an antenna array within the base station;
l is an antenna element index along a second dimension in the antenna array within the base station;
θ_{H} is a step size for a phase change between adjacent antenna elements in the antenna array in the first dimension;
θ_{V} is a step size for a phase change between adjacent antenna elements in the antenna array in the second dimension;
N₁ is the total number of antennas in the antenna array in the first dimension;
N₂ is the total number of antennas in the antenna array in the second dimension;
c₀ is a constant of a quadratic polynomial in the first dimension;
c is a quadratic coefficient of the quadratic polynomial in the first dimension;
d₀ is a constant of a quadratic polynomial in the second dimension; and
d is a quadratic coefficient of the quadratic polynomial in the second dimension.

12. The method of claim 11, wherein when antennas in the antenna array have dual polarization directions, the codebook is extended and described in the following form:
$${W}_{l , m , n} = α [ \begin{matrix}{v}_{l , m} \\ {ϕ}_{n} \cdot {v}_{l , m}\end{matrix} ] ; {ϕ}_{n} = {e}^{j 2 π n}$$
where α is a scaling factor, an upper half of W_{l,m,n} corresponds to antennas with one polarization direction, while a lower half of W_{l,m,n} corresponds to antennas with another polarization direction.

13. The method of claim 12, wherein the dual polarization directions are the same.

14. An apparatus for wireless communication, the apparatus being a user equipment (UE), comprising:
a memory; and
at least one processor coupled to the memory and configured to:
report, to a base station, a parameter set associated with a codebook determined based on a quadratic model, wherein the parameter set is used for determining, based on the codebook, phase adjustments for signals to be transmitted by the base station; and
receive, from the base station, the signals transmitted in accordance with the parameter set.

15. The apparatus of claim 14, wherein the parameter set comprises:
a coefficient set of the quadratic model; and
a step size for a phase change unit between adjacent antenna elements in an antenna array within the base station, the antenna array being used to transmit the signals.

16. The apparatus of claim 15, wherein the coefficient set is used to determine scaling factors applied to the step size to obtain the phase adjustments.

17. The apparatus of claim 15, wherein the antenna array comprises a two-dimensional (2D) antenna array.

18. The apparatus of claim 17, wherein:
the coefficient set comprises a first coefficient set of a quadratic polynomial for a first dimension and a second coefficient set of a quadratic polynomial for a second dimension; and
the step size comprises a first step size for a phase change between adjacent antenna elements in the first dimension and a second step size for a phase change between adjacent antenna elements in the second dimension.

19. The apparatus of claim 15, wherein the coefficient set comprises a quadratic coefficient, a linear coefficient and a constant, and wherein any one of the quadratic coefficient, the linear coefficient and the constant is normalized to 1.

20. A computer-readable medium storing computer executable code for wireless communication of a user equipment (UE), comprising code to:
report, to a base station, a parameter set associated with a codebook determined based on a quadratic model, wherein the parameter set is used for determining, based on the codebook, phase adjustments for signals to be transmitted by the base station; and
receive, from the base station, the signals transmitted in accordance with the parameter set.
